(19) United States
(12) Patent Application Publication
(10) Pub. No.: US 2014/0044888 A1
(43) Pub. Date: Feb. 13, 2014

(54) PROCESS FOR THE MANUFACTURE OF ELECTRODES

(71) Applicants: Tim Schaefer, Harztor (DE); Guenter Eichinger, Altenstadt (DE)

(72) Inventors: Tim Schaefer, Harztor (DE); Guenter Eichinger, Altenstadt (DE)

(73) Assignee: Li-Tec Battery GmbH, Kamenz (DE)

(21) Appl. No.: 13/985,268

(22) PCT Filed: Jan. 26, 2012
(86) PCT No.: PCT/EP12/00357

§ 371 Date: Oct. 24, 2013

(30) Foreign Application Priority Data
Feb. 14, 2011 (DE) 10 2011 011 155.7

(51) Int. Cl. H01M 4/04

(52) U.S. Cl. CPC H01M 4/0402
USPC 427/553; 264/446

(57) ABSTRACT

A method for producing an electrode, in particular a negative electrode of an electrochemical cell, comprising the steps of: pretreatment, in particular cleaning, of a metallic substrate, drying the pretreated metallic substrate and/or an active material, and coating the pretreated metallic substrate with the active material, wherein said pretreatment of the surface of the metallic substrate involves an organic acid.

The entire content of priority application DE 10 2011 011 155.7 is herewith incorporated by reference into the present application.

The present invention relates to a method for the production of electrodes, particularly for negative electrodes for electrochemical cells. These electrochemical cells can be preferably used for powering a vehicle having an electrical motor, preferably with hybrid drive and/or in “plug in” mode.

Electrochemical cells, in particular lithium secondary batteries are used for energy storage in mobile information equipment such as mobile phones, in power tools or electrically powered cars and in cars with hybrid drive, due to their high energy density and high capacity. In these different applications, in particular in regard to powering automobiles, these electrochemical cells must meet high demands: high capacitance and energy density, which remains stable over a large number of charge and discharge cycles, while having as minimal a weight as possible.

In particular longevity of electrochemical cells is often dependent on the aging of the electrodes, in particular the aging of the negative electrodes. In the aging process, electrochemical cells lose capacity and performance. This process takes place, to some extent, in most of the common electrochemical cells, and is highly dependent on the operating conditions (temperature, storage conditions, state of charge, etc.) but also on the quality, and the processing of the materials during the manufacturing process of the electro chemical cell. Thus, high-quality processing of pure materials leads to long-lived electrochemical cells that age only little over a long period of time, and therefore loose little capacity and performance over time.

Since the purity of the materials used is often subjected to physical or chemical limits, for example due to synthesis, a primary objective of a battery manufacturer to obtain electrochemical cells of higher quality and therefore more durable electrochemical cells by means of optimizing the manufacturing process of the electrodes, such as disclosed in EP 2 006 942.

In the light of the prior art, one object of the invention is to provide an improved process (method) for the production of electrodes, particularly for negative electrodes of durable electrochemical cells.

This is achieved according to the teaching of the independent claims of the present invention. Preferred embodiments of the invention are the subject matter of the dependent claims.

To solve this problem, as described in detail below, a method for the manufacture of electrodes for electrochemical cells is provided, in particular for the negative electrode (anode), comprising the steps of:
pretreatment, in particular at least partial cleaning, of a metallic substrate, preferably a collector foil, further preferably a collector comprising copper;

drying of the pretreated metallic substrate and/or drying of an active material, in particular an anode active material of the negative electrode;
applying the active material, in particular comprising a binder, onto the metallic substrate as pretreated.

The pretreatment, in particular the at least partial cleaning of the surface of the metallic substrate is preferably effected with an organic acid, preferably with oxalic acid, in particular with a time delay in respect to the application of the active material, in particular an anode active material of the negative electrode, preferably with a binder, onto the metallic substrate.

By means of the inventive combination of method steps, the particular advantage is realized that an improved and well adhering coating of the metallic substrate is obtained in respect to the anode-active material, resulting in a reduced aging of the anode, and thus of the electrochemical cell. In this way, the performance stability, particularly the stability in respect to the capacitance of an electrochemical cell, may be improved.

The term “electrochemical cell” is understood to mean any device for the electric storage of energy. The term therefore defines, in particular, electrochemical cells of the primary or secondary type, but also relates to other forms of energy storage devices, such as capacitors. A preferred electrochemical cell in accordance with the present invention is a lithium ion battery cell that may be part of a battery.

The term “negative electrode” means that the electrode provides electrons to a load, for example when connected to an electrical motor. Thus, the negative electrode is the anode in accordance with this convention. Correspondingly, the term “positive electrode” means that the electrode takes up electrons when connected to a load, for example to an electrical motor. Thus, the positive electrode is the cathode in accordance with this convention.

An electrode, i.e. a positive electrode and/or a negative electrode, which is produced by the method of the invention comprises at least a metallic substrate and at least an electrochemically active material.

In one embodiment, the electrode as prepared in accordance with the invention comprises, in addition to the metallic substrate and the electrochemically active material (preferably, the anode active material) at least one further additive, preferably an additive to increase the conductivity, such as a carbon-based material, such as carbon black, and/or a redox-active additive, which reduces, preferably minimizes, and preferably prevents the destruction of the electrochemically active material in the event of overload of the electrochemical cell.

The term “metallic substrate” preferably refers to the part of cell, which is known as “electrode support” or “collector”. In the present case, the metallic substrate is suitable for the application of active material, and is substantially metallic in nature, preferably completely metallic in nature.

Preferably, the metallic substrate is at least partially configured as a film or a net structure or a mesh/web (“Gewebe”), preferably comprising copper or a copper-containing alloy, in particular as rolled copper, in particular as a copper sheet, which is, in particular, treated continuously or stepwise by means of the inventive method.

In a further embodiment, the metallic substrate comprises aluminum.

In one embodiment, the metallic substrate may be configured as a sheet, web or woven structure, which preferably at least partially comprises plastics.

The inventive method preferably comprises a step, in which the metallic substrate, in particular the surface of the metallic substrate, is pretreated with a time delay in regard to the application of the active material with an organic acid, in particular, the substrate has been at least partially cleaned and preferably has been completely cleaned.

The term “time delay” means that between the treatment, in particular the at least partial cleaning of the metallic substrate, in particular the surface of the metallic substrate, with an organic acid, and the application of the active composition onto the pretreated metallic substrate, a time difference dt>0 lapses. The treatment, in particular the at least partial cleaning the metallic substrate with an organic acid, takes place before the application of the active composition onto the pretreated metallic substrate. The time difference dt between the treatment, in particular the at least partial cleaning of the metallic substrate with an organic acid, and the application of the active composition onto the pretreated, in particular the at least partially purified collector, preferably is up to dt=3 hours, preferably up to 2 hours, preferably up to one hour.

In a preferred embodiment, the time difference between the pretreatment, in particular the at least partial cleaning of the metallic substrate, in particular of the surface of the metallic substrate with an organic acid, and the application of the active composition onto the pretreated, in particular onto the at least partially cleaned metallic substrate, is between 30 minutes and 40 minutes, preferably 35 minutes (+/−2 minutes).

This time delay between the treatment, in particular the at least partial cleaning of the metallic substrate, in particular of the surface of the metallic substrate, with an organic acid and the application of an electrochemically active material onto the pretreated, in particular an at least partially cleaned metallic substrate, is advantageous in that a particularly effective cleaning is possible, wherein, preferably up to 50% of the impurities are removed, and particularly preferably up to 100% of the metallic impurities are removed from the substrate, and in particular from the top surface.

The term “organic acid” is to be understood to relate to a chemical compound, which has a chemical acid group O═X—OH, i.e. which has a central atom (X), to which an OH group is bound by a single bond between the central atom, X ,and the O atom of the OH-group, and which comprises a further oxygen atom, which is bound to the central atom X by a double bond. The central atom of X may be selected from the group of non-metals or semi-metals of the periodic system of chemical elements (PSE), which are capable of binding to an oxygen atom through formation of a double bond, and simultaneously with the oxygen atom O of the OH group by formation of a single bond. Preferably, the central X atom is selected from the group of carbon, sulfur, phosphorus, silicon; carbon is particularly preferred.

Furthermore, the central atom of X is additionally bound to another atom, preferably a carbon atom which is part of an organic substituent, which is selected from alkyl or aryl, which substituent, in addition to carbon and hydrogen atoms, may comprise additional further heteroatoms, preferably nitrogen, oxygen, sulfur or phosphorus. The use of the term “organic acid” in the singular does not exclude that said organic acid may also be a mixture of various organic acids. If the organic acid is a “solid” acid, i.e. an acid, which is is present at the standard temperature (25° C.) as a solid, it is preferable to dissolve the acid, before use, in an appropriate solvent. Preferably, the organic acid and/or the solvent has a water content of less than 20%, preferably less than 10%, preferably less than 5%, preferably less than 2% and more preferably 1% or less.

In one embodiment, the organic acid is selected from acetic acid, succinic acid, fumaric acid, citric acid, maleic acid, oxalic acid, lactic acid, pyruvic acid, formic acid, oxal succinic acid, oxalic acid or mixtures thereof.

In a preferred embodiment, the organic acid—optionally together with other components—is oxalic acid (also called “ethane di-acid”).

In a particularly preferred embodiment, the organic acid is provided as an “anhydrous” oxalic acid, which is commercially available under the CAS No. 144-62-7. “Water-free” means that the water content of oxalic acid is 1% or less.

The use of organic acid, in particular oxalic acid has the advantage that the organic acid can be degraded by, for example, heating or UV irradiation. The resulting decomposition products of the organic acids are mainly CO₂ and water, and can be disposed of or removed, respectively. In addition, the handling of organic acids in essentially simpler and less dangerous than dealing with, for example, chromic acid, as used, for example, in the Corona—etching process. This is particularly relevant in the case of the present application, wherein an aging-resistant foil collector for electrochemical cells should be provided.

In a further particularly preferred embodiment, the organic acid is provided as “anhydrous”, oxalic acid, and is at least partially dissolved in NMP (N-methyl-2-pyrroli don), which preferably has a water content of less than 100 ppm (=parts per million), preferably less than 60 ppm, preferably less than 30 ppm, preferably less than 10 ppm and is provided free from impurities, and in so-called “Quality Battery”, that is, in essence, free of amine impurities.

The use of anhydrous organic acids, in particular of anhydrous oxalic acid has the advantage that impurities in the metallic substrate, in particular on the surface thereof, and in particular in case the metallic substrate is provided as a copper foil, may be removed efficiently and easily, at least partially, preferably completely. The contamination of the surface of the metallic substrate may be caused by storage, transport, packaging or may have been caused during the preparation of the metallic substrate. Contaminants may adversely affect, for example, the adhesion of electrochemically active material onto the surface of the metallic substrate, causing the electrochemical cell to “age” faster, or may even negatively affect the function of the metallic substrate, namely the uptake or release of electrons from or to the electrochemically active material, which negative effect may be manifested, for example, in the form of increased internal resistance and a consequent loss of performance or capacity of the electrochemical cell.

In one embodiment, the metallic substrate is or comprises copper or a copper-containing film, in particular copper foil, which is associated with the problem that the surface of the copper foil collector is often brought in contact with impurities during its manufacture, for example during a rolling process or cutting process, often with fatty and/or oily substances, in particular with beef tallow, or dust particles. Furthermore, the surface of the copper-containing film, in particular of a copper foil is at least partially passivated during prolonged contact with ambient air, i.e. by means of oxidation a passivation layer forms, which may comprise, in one embodiment, copper (I) oxide, Cu₂O, which is also considered as an impurity. Therefore, the use of organic acids having organic substituents proves to be advantageous because the organic fatty and/or oily substances (impurities) at least partially, preferably completely, dissolve in the organic acid, and thus can be removed from the surface of the metallic substrate in accordance with the chemical principle “similia similibus solvuntur” (similar dissolves similar). Another advantage of the use of organic acids is that the passivation layer, in one embodiment, comprising copper (I) oxide Cu₂O is at least partially, preferably completely, removable. Preferably, the so treated and cleaned surface, in particular the at least partially cleaned surface of the metallic substrate, does not undergo further reactions with the organic acid.

In a particularly preferred embodiment, the metallic substrate is realized as a copper-containing film, in particular as a copper foil, whose surface is at least partially contaminated with oily and/or fatty substances, in particular with beef tallow, and/or a passivation layer comprising at least partly, copper (I) oxide, Cu₂O, and is treated with an organic acid, preferably with anhydrous oxalic acid, at least partially, preferably completely, and is thereby, in particular, at least partially, preferably entirely, freed from these contaminants.

The term “cleaning” and “to clean” is meant that preferably up to 50%, preferably up to 70%, preferably up to 100% of the impurities are removed from the surface of the metallic substrate, however preferably at least 5%, 10%, 15%, 20%, 25%, 30%, 35%, 40%, 45%, 50%, 55%, 60%, 65%, 70%, 80%, 85%, 90%, 95% of the impurities are removed from the surface of the metallic substrate.

The terms “treatment” and “treating” or “to treat” and “pretreat” are to be understood that preferably up to 50%, preferably up to 70%, preferably up to 100% of the surface of the metallic substrate have come into contact with organic acid and have been, in particular, wetted, wherein, in each case, preferably at least 5%, 10%, 15%, 20%, 25%, 30%, 35%, 40%, 45%, 50%, 55%, 60% , 65%, 70%, 80%, 85%, 90%, 95% of the surface of the metallic substrate come into contact with an organic acid and are, in particular wetted with said organic acid.

The wetting of the surface of the metallic substrate with an organic acid takes place, in one embodiment, by means of spraying the surface of the metallic substrate with an organic acid.

In another embodiment, the wetting of the surface of the metallic substrate with an organic acid is achieved by sprinkling the surface of the metallic substrate with an organic acid.

In another embodiment, the wetting of the surface of the metallic substrate is achieved through an immersion bath of the metallic substrate in organic acid.

In another embodiment, the wetting of the surface of the metallic substrate with an organic acid is achieved by means of a device, for example of a roller, whose surface is wetted with an organic acid, wherein said organic acid is at least partially transmitted onto the surface of the metallic substrate by means of contact with the surface of said device.

In another embodiment, the treatment of the surface of the metallic substrate with an organic acid is achieved by exposing the metallic substrate to vapor deposition in a steam comprising or consisting of organic acid. This allows for a particularly uniform treatment of a surface, in particular essentially free of “wetting” or “de-wetting” effects. The treatment preferably takes place at temperatures of at least 85° C., 100° C., 150° C. The treatment may comprise a steam jet so that the steam applies a pressure on the surface to be treated, which causes a mechanical cleaning effect. The pressure is, in each case, preferably at least 1 bar, 2 bar, 5 bar, 10 bar, 25 bar, 50 bar, 100 bar, 200 bar or 500 bar, but the pressure or ambient pressure in regard to the metallic substrate may also be 1 bar. The cross section of the steam jet may have an area AD, which corresponds at least to AO, which is the area of the surface that is to be treated. However, it is also possible, and preferred, that this cross-section of AD corresponds to a fraction f of the area AO (AD=f*AO), and is, preferably at least, or at most, f=0.5, 0.25, 0.1, 0, 05. The cross section of the steam jet has, in each case, and preferably, a shape that is substantially a rectangle, a line or a strip.

The treatment of the metallic substrate, in particular the cleaning thereof, preferably uses a plasma, in particular a plasma stream, in particular at an ambient pressure of between 0.05 bar and 1 bar vis-à-vis the metallic substrate. Plasma is a gas that partially or completely consists of free charge carriers, such as ions or electrons, and is, for example, produced by electrical treatment of a gas in an electric alternating field, as obtained, for example in commercially available plasma systems. The plasma can be generated using oxygen or an organic acid. In this context, the temperature may be chosen arbitrarily, in particular substantially room temperature. The result is a more flexible and gentle cleaning.

It is then also possible, and preferred, that the organic acid, in particular the organic acid of a steam jet, and the surface to be treated are moved relative to each other, preferably at a constant speed, to achieve a more uniform result, preferably by means of, for example, by means of moving the surface to be treated against the organic acid (or the steam jet); alternatively, the organic acid (or the steam jet) is moved against the surface to be treated.

In one embodiment, the wetting of the surface of the metallic substrate is followed by a further process step, in which the organic acid is distributed evenly over the surface of the metallic substrate by means of mechanical operations, such as shaking.

In one embodiment, the uniform distribution of the organic acid over the surface of the metallic substrate takes place simultaneously with the wetting of the surface of the metallic substrate with an organic acid.

In one embodiment, the method comprises a mechanical cleaning of the surface of the metallic substrate, which can be achieved, for example, by means of applying friction by means of brushes or textile. The step of mechanical treatment may be implemented prior to the wetting the surface of the metallic substrate with organic acid, or also during the wetting of the surface of the metallic substrate with an organic acid, or also subsequently to the wetting.

In a preferred embodiment, the process steps of wetting the surface of the metallic substrate with an organic acid, of evenly distributing the organic acid on the surface of the metallic substrate, and the step of mechanical cleaning of the surface of the metallic substrate are combined in a single process step, which for example, may be implemented via a steam jet comprising the organic the acid, or may be implemented by the use of movable brushes, wherein the organic acid is taken from a storage container filled with the organic acid, and the surface can therefore be wetted continuously with the latter, and therefore apply the organic acid by means of contact with the surface of the metallic substrate. The movable brushes may perform, for example, circular motions on the surface of the metallic substrate, so that the organic acid is uniformly distributed over the surface of the metallic substrate. By means of optional application of pressure, via the brushes, onto the surface of the metallic substrate, said substrate is cleaned, at the same time, mechanically.

However, other processes known in the art for a “wet-chemical” surface cleaning, particularly the cleaning of metal surfaces, are included as well.

The residence time of the organic acid on the surface of the metallic substrate is preferably up to 30 seconds, preferably up to 5 minutes, preferably up to 30 minutes, preferably up to 60 minutes, preferably up to two hours. The residence time may also be longer or shorter.

Preferably, after the predetermined residence time in respect to the organic acid on the surface of the metallic substrate is reached, a drying step is performed in addition, during which the organic acid is at least partially, preferably completely, continuously removed from the surface of the metallic substrate.

In a preferred embodiment of the present invention, the treated, in particular the at least partially purified metallic substrate, is irradiated with UV light prior to applying the active material, in particular the active material of the anode active material.

In one embodiment, before, during or after UV exposure, a heat treatment of the metallic substrate is implemented, so that the temperature of the metallic substrate, preferably the surface temperature of the metallic substrate after the heat treatment, is higher than the temperature of the metallic substrate, preferably higher than the surface temperature of the metallic substrate prior to the heat treatment. Preferably, the temperature of the metallic substrate, preferably the surface temperature of the metallic substrate after the heat treatment, is higher than 25° C., preferably higher than 40° C.

In a preferred embodiment, the temperature of the metallic substrate, preferably the surface temperature of the metallic substrate, after the heat treatment, is higher than 25° C., but not higher than 60° C. Preferably, in this embodiment, the metallic substrate comprises copper, and is preferably designed as a copper-containing film, in particular as a copper foil.

Preferably, the metallic substrate, in particular the surface of the metallic substrate during application of the active material, in particular of the anode active material is at a temperature, which is higher than 25° C., preferably higher than 40° C. The expression “during application” refers to the total time period, which is required to apply the active material onto the metallic substrate.

Therefore, the metallic substrate, in particular the surface of the metallic substrate, should have a temperature, after the completion of the heat treatment of the metallic substrate, which is high enough that the heat loss, which may occur between the termination of the heat treatment and commencement of application of the active material, which, for example, may be the case when the metallic substrate must be moved, for example, in a different factory building, is not so great that the temperature of the metallic substrate, in particular the surface of the metallic substrate at the beginning of the application of the active material, still is at least 25° C. or higher, preferably at least 40° C. or higher.

In one embodiment this is achieved by means of temperature-controlled conveyors.

In a preferred embodiment, the metallic substrate, and, in particular, the surface of the metallic substrate has a temperature, which is higher than 25° C., but not higher than 60° C. during the application of the active material, in particular of the anode active material. Preferably, in this embodiment, the metallic substrate comprises copper and preferably is realized as a copper-containing film, in particular as a copper foil.

The temperature-control of the metallic substrate, in particular the surface of the metallic substrate to a temperature of preferably 25° C. to 60° C. has the advantage that the adhesion of the electrochemically active material to the surface of the metallic substrate is increased. This is particularly advantageous in connection with the pretreatment according to the present invention, in a synergetic manner.

Preferred methods of applying the active material, in particular of the anode active material, are paste extrusion methods, “dye-coating” methods, spraying methods, or “slurry” methods.

Preferably, after the application of the active material, in particular of the anode active material, up to 30%, preferably up to 50%, preferably up to 70%, preferably up to 100% of the total surface of a metallic substrate comprise the active material, in particular the anode active material.

Preferably, the active material, in particular, the anode active material is materially bonded at least partially, preferably completely, with the surface of the metallic substrate.

Prior to applying the active material to the metallic substrate, this active material is preferably prepared in a separate method step.

This method preferably has the following steps:
providing the electrochemically active material,
drying the electrochemically active material as provided,
mixing the dried electrochemically active material with a solvent, which solvent is capable to dissolve further additives, but not the electrochemically active material itself, at least partially (or substantially completely),
addition of other additives (optional)
drying of the pre-active mass,
adding a binder, which is soluble in the solvent used, and mixing with the same with the preactive mass,
providing the resulting active composition for subsequent application onto the metallic substrate.

The above-mentioned process steps are preferably carried out in one single apparatus, according to one embodiment.

In another embodiment, above-mentioned method steps are carried out in different apparatuses.

Preferred apparatuses for performing the above process steps for producing the active material are mixer and dryer, in particular a vacuum mixer and dryer, which may have, in one embodiment, a horizontal alignment (that is perpendicular to the direction of gravity), and, in another embodiment, a vertical alignment (that is parallel have to the direction of gravity). Such devices are sold, for example, by the companies Eirich, MasterCard or Coatema or are known by the name Drais turbo.

The term “electrochemically active material” is to be understood to relate to a material, which is suitable for the storage and retrieval of redox components, in particular of lithium ions.

In one embodiment, the electrochemically active material is a cathode active material.

In a preferred embodiment, the electrochemically active material is an anode material. The anode active material is preferably carbonaceous.

In one embodiment, the electrochemically active material is dried.

In one embodiment, the electrochemically active material has a water content of less than 200 ppm, preferably of less than 100 ppm, preferably less than 50 ppm, after drying, respectively.

In one embodiment, in addition to the electrochemically active material, at least one additive is added prior to drying.

After completion of the drying step in respect to the electrochemically active material, or the electrochemically active material and the least one additive, a solvent is preferably added, which is capable of dissolving the binding agent or the binder and the at least one additive, but not the electrochemically active material. Preferably, the solvent is at least partially, preferably completely, free of water.

In one embodiment, the solvent is or comprises N-methyl-2-pyrrolidone (NMP),In a particularly preferred embodiment the solvent is realized as N-methyl-2-pyrrolidone, which is substantially free of impurities such amines. Such a quality level is known in the art as “Battery Quality”. Further preferably, the NMP is substantially free of water and preferably has a water content of less than 150 ppm, preferably of less than 100 ppm, preferably of less than 50 ppm.

In one embodiment, the solvent which comprises or preferably essentially consists of NMP, preferably comprises an additive, preferably a conductive additive, and is then injected into the dried electrochemical material, and thereby results in a preactive mass, which is characterized in that said preactive mass comprises at least one electrochemically active material, preferably an anode active material, at least one solvent, preferably NMP, and, optionally, at least one additive, preferably a conductivity additive, but no binder, that is, for example, no PVDF. It is further preferred that the preactive mass is present in a consistency, which is suitable to be used in the application step performed later (for example, by means of paste extrusion).

Said preactive mass preferably has a water content of below 100 ppm, preferably below 50 ppm, preferably between 10 and 30 ppm. In case the water content is higher than 100 ppm, the preactive mass should be subjected to a drying step, wherein the water content should preferably be brought below 100 ppm, preferably be brought to less than 50 ppm, preferably to 10 to 30 ppm.

In one embodiment, a binder is added to the preactive mass, which has a water content of preferably less than 100 ppm, preferably less than 50 ppm, preferably from 10 to 30 ppm, further comprises at least one electrochemically active material, preferably an anode active material, at least one solvent, preferably NMP, and, optionally, at least one additive, preferably a conductive additive. By means of this, an active material may be obtained which is, preferably, an anode active material.

The binder is preferably capable of improving, in particular, the adhesion between the active material and the surface of the metallic substrate. Preferably, such a binder is a polymer, preferably a fluorinated polymer, preferably polyvinylidene fluoride (PVDF), which is sold under the trade names Kynar®, Solef®, Kureha® or Dyneon®. PVDF copolymers having a high molecular weight are preferable, for example copolymers known under the trade name of Kureha 9200 ®.

The active material so obtained, in particular, the anode active material having a water content of preferably less than 100 ppm, preferably less than 50 ppm, preferably between 10 and 30 ppm, further comprising at least one electrochemically active material, preferably an anode active material, at least one solvent , preferably NMP, at least one binder, preferably PVDF, and, optionally, at least one additive, preferably a conductive additive, is suitable to be applied to the pretreated metallic substrate.

After application of the active material, in particular of the anode active material, onto the metallic substrate, in particular a copper metal collector, a drying step and optionally a treatment with UV light, concludes the process.

In one embodiment, the electrochemical cell according to the present invention comprises at least one electrode, which was made in accordance with the inventive method, wherein the electrode, preferably the negative electrode comprises a metallic substrate, which is preferably configured to comprise copper and to be a film, and the total surface area is preferably up 30%, preferably up to 50%, preferably up to 70%, preferably up to 100% coated with active material, preferably is coated with the electrochemically active material in material contact (“stoffschlussig”), and preferably contains a carbonaceous material, preferably selected from crystalline graphite or amorphous graphite or mixtures thereof, and additionally comprise a binder which is capable of improving the adhesion between the active material and the metallic substrate. Preferably, such a binder comprises a polymer, preferably a fluorinated polymer, preferably polyvinylidene fluoride.

A battery of the invention preferably comprises at least one electrochemical cell according to the invention.

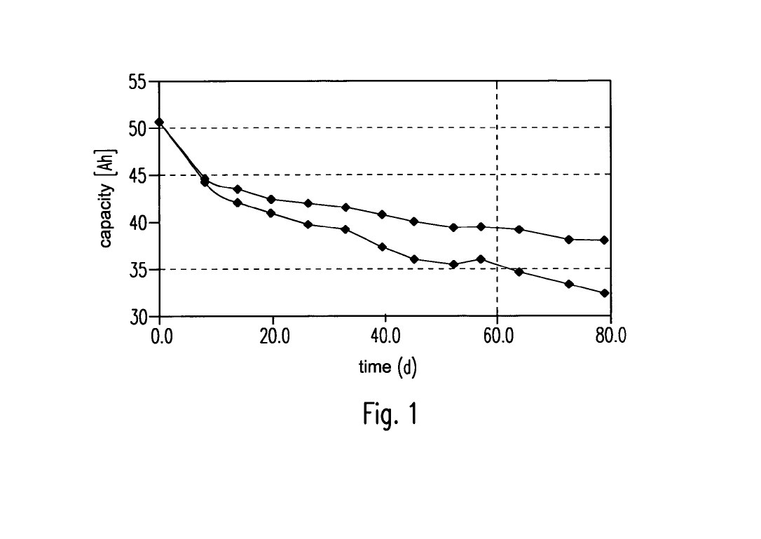

FIG. 1 shows a graph of the capacitance versus time, as obtained for a battery in accordance with the present invention vis-à-vis a conventional battery cell, wherein the battery cell anode according to the invention has been produced by a method according to the invention.

### EXAMPLE IN ACCORDANCE WITH THE INVENTION

In one embodiment of the inventive process, a copper foil, namely a thin copper sheet that is used as a substrate for the anode of an electrode stack of a lithium ion battery cell, is pretreated with an organic acid (in this case with oxalic acid), which is dissolved in

NMP. After completion of the treatment with an organic acid, which is performed, in particular, for the purpose of an at least partial cleaning of the surface of the copper foil, the copper foil is treated with ultraviolet irradiation and kept at a temperature of 25° C. to 60° C. At this temperature, the surface of the copper foil surface is coated with the anode active material. This active material is prepared as follows: an electrochemically active material for the anode based on carbon is provided and dried. NMP is then added to the dried electrochemically active material (here: injected). In this embodiment, NMP is injected together with a conductive additive. After completion of the injection of NMP comprising a conductive additive, the preactive mass so obtained is brought down to a water content of 30-10 ppm (i.e. is dried). Subsequently, PVdF is added as a binder, thus completing the active material. This active material is then applied onto the surface of the copper foil.

This inventive combination of method steps is associated with the particular advantage that a very good adhesion, in particular in regard to the coating of the metallic substrate, is obtained in respect to the anode active material, whereby aging of the anode, and thus of the electrochemical cell, is reduced. As a consequence, the performance stability, in particular the stability of the capacitance of an electrochemical cell, may be improved. In the embodiment of the method according to the invention, a battery cell is manufactured, comprising an anode made in accordance with the invention, wherein the capacitance as shown in FIG. 1 (upper curve) dropped over a period of 80 days under simulated high load. The corresponding drop in capacitance of a conventionally produced, commercially acquired battery cell (lower curve; same load), after 80 days, was higher by 14% (compare 38 Ah vs. 32 Ah).

1-11. (canceled)

12. A method for the manufacture of an electrode, in particular a negative electrode, of an electrochemical cell, comprising:
pretreatment, in particular cleaning, of a metallic substrate;
drying of the pretreated metallic substrate and/or drying of an active material; and
applying the active material onto the metallic substrate as pretreated;
wherein said pretreatment of the surface of the metallic substrate involves an organic acid, wherein said organic acid is oxalic acid, wherein said pretreatment is performed in addition to UV irradiation, wherein said acid is degraded.

13. The method according to claim 12, wherein the metallic substrate comprises copper foil or a thin copper sheet.

14. The method according to claim 12, wherein the metallic substrate, in particular the surface of the metallic substrate, has a temperature of from 25° C. to 60° C. during the coating with an active material.

15. The method according to claim 12, wherein the active material comprises at least one electro chemically active material and at least one solvent, and at least one binder.

16. The method according to claim 15, wherein the active material further comprises a conductive additive.

17. The method according to claim 15, wherein the binder comprises polyvinylidene fluoride (PVDF).

18. The method according to claim 12, wherein the active material at least one of (a) is the anode active material and (b) comprises less than 100 ppm of water.

19. The method according to claim 12, wherein the coating of the surface of the metallic substrate with active material is performed 30 to 40 minutes after the pretreatment, in particular wherein the cleaning of the metallic substrate is carried out with organic acid.

20. The method according to claim 12, wherein the coating of the surface of the metallic substrate with active material is implemented by means of slurry techniques or dye coating methods or paste extrusion or injection molding.
